(19) United States
(12) Patent Application Publication
(10) Pub. No.: US 2015/0242131 A1
(43) Pub. Date: Aug. 27, 2015

(54) STORAGE CONTROL DEVICE AND STORAGE APPARATUS

(71) Applicant: FUJITSU LIMITED, Kawasaki-shi (JP)

(72) Inventors: Masatoshi NAKAMURA, Machida (JP); Koutarou Nimura, Kawasaki (JP); Marie Abe, Kawasaki (JP); Yoshihito Konta, Kawasaki (JP); Hideo Takahashi, Yokohama (JP)

(21) Appl. No.: 14/607,682

(22) Filed: Jan. 28, 2015

(30) Foreign Application Priority Data
Feb. 21, 2014 (JP) 2014-032037

(51) Int. Cl. G06F 3/06; G11B 20/12; G11B 5/55

(52) U.S. Cl. CPC G06F 3/0611; G11B 5/5547; G06F 3/0659; G06F 3/0676; G11B 20/1252; G11B 2020/1242

(57) ABSTRACT

An HDD driving unit 20 that queues a command for each zone that is acquired by dividing a storage region, and that issues commands from a queue of each zone in a consecutive manner includes a mode switching unit 29 that updates a threshold value of consecutive issuance of commands to a single zone based on an access condition to an HDD 9 and a command issuing unit 27 that controls issuance of a command to each zone based on the threshold value updated by the mode switching unit 29.

### CROSS-REFERENCE TO RELATED APPLICATION

This application is based upon and claims the benefit of priority of the prior Japanese Patent Application No. 2014-032037, filed on Feb. 21, 2014, the entire contents of which are incorporated herein by reference.

### FIELD

The embodiments discussed herein are directed to a storage control device and a storage apparatus.

### BACKGROUND

Access time of a hard disk drive (HDD) used in a storage apparatus includes seek time, rotation waiting time, and data transfer time. Among these, the seek time requires the most time. Accordingly, as a conventional technique to reduce seek time, there has been a technique in which a region in a disk is divided into multiple zones, and commands to access to a specific zone are consecutively issued, to suppress seek loss.

Moreover, as a conventional technique to reduce seek time, there has been a technique in which commands transmitted from a higher-level computer are rearranged according to addresses of data such that consecutive regions are accessed. Furthermore, there has been a conventional technique to prevent timeout of a command to which a low priority is given by re-ordering to give the highest priority in processing order to a command to access to a cylinder closest to a cylinder to which a header is positioned.

Moreover, there has been a conventional technique in which a new command is not issued when the number of commands that have been issued for a device having a command queuing function and for which completion has not been informed is not smaller than the limit number.

### CITATION LIST

### Patent Literature

Patent Literature 1: Japanese Laid-open Patent Publication No. 2008-16027
Patent Literature 2: Japanese Laid-open Patent Publication No. 06-259198
Patent Literature 3: Japanese Laid-open Patent Publication No. 05-134810
Patent Literature 4: Japanese Laid-open Patent Publication No. 2000-99446)

However, in the technique in which a region in a disk is divided into zones and commands to access to a specific zone is consecutively issued, there is a problem that command sinking occurs. Command sinking is that issuance of one command is forced to wait for a long time by issuance of another command.

FIG. 18 indicates an example of command sinking. FIG. 18 indicates a case in which 20 zone queue₀ to zone queue₁₉ are present, and 51 commands are present in the zone queue₀. Furthermore, a threshold value indicating the maximum number of commands to be issued consecutively from a single zone queue is 50.

In FIG. 18, when 50 commands are issued from the zone queue₀, a zone queue from which a command is issued is switched. Therefore, the 51st command of the zone queue₀ is required to wait until threshold value (50)×(number of zones (20)−1)=950 commands are issued for the most, and thus command sinking occurs.

To prevent command sinking, reduction of the threshold value can be considered; however, if the threshold value is too small, switch of zone queues from which a command is issued occurs frequently, and the advantage of using zone queues is lost.

### SUMMARY

According to an aspect of an embodiment, a storage control device that queues a command for each zone that is acquired by dividing a storage region, and that issues commands from a queue of each zone in a consecutive manner includes an updating unit that updates a threshold value of consecutive issuance of commands to a single zone based on an access condition to the storage region; and an issuance control unit that controls issuance of a command to each zone based on the threshold value updated by the updating unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a block diagram indicating a configuration of a storage disk-array device according to a first embodiment;

FIG. 2 indicates a storage location of controller module (CM) firmware and execution of the CM firmware by a central processing unit (CPU);

FIG. 3 is a block diagram indicating a functional configuration of an HDD driving unit;

FIG. 4 indicates an example of queuing operation;

FIG. 5 indicates an example of dequeue operation;

FIG. 6 indicates an example of a method of determining sequential access;

FIG. 7 indicates a mode determination method;

FIG. 8 indicates an example of threshold value corresponding to each mode;

FIG. 9 is a flowchart indicating a flow of a mode determination processing;

FIG. 10 is a flowchart indicating a flow of a command reception processing;

FIG. 11 is a flowchart indicating a flow of a command issuance processing;

FIG. 12 is a block diagram indicating a functional configuration of an HDD driving unit according to a second embodiment;

FIG. 13 indicates an example of adjustment values stored in an adjustment-value storage unit;

FIG. 14 indicates an example of the adjustment values based on a performance ratio;

FIG. 15 is a flowchart indicating a flow of a threshold update processing according to the second embodiment;

FIG. 16 indicates an example of a determination table that holds determination results of a threshold value;

FIG. 17 is a flowchart indicating a flow of a threshold determination processing according to a third embodiment; and

FIG. 18 indicates an example of command sinking.

### DESCRIPTION OF EMBODIMENTS

Preferred embodiments of the present invention will be explained with reference to accompanying drawings. The disclosed technique is not limited to the embodiments.

### [a] First Embodiment

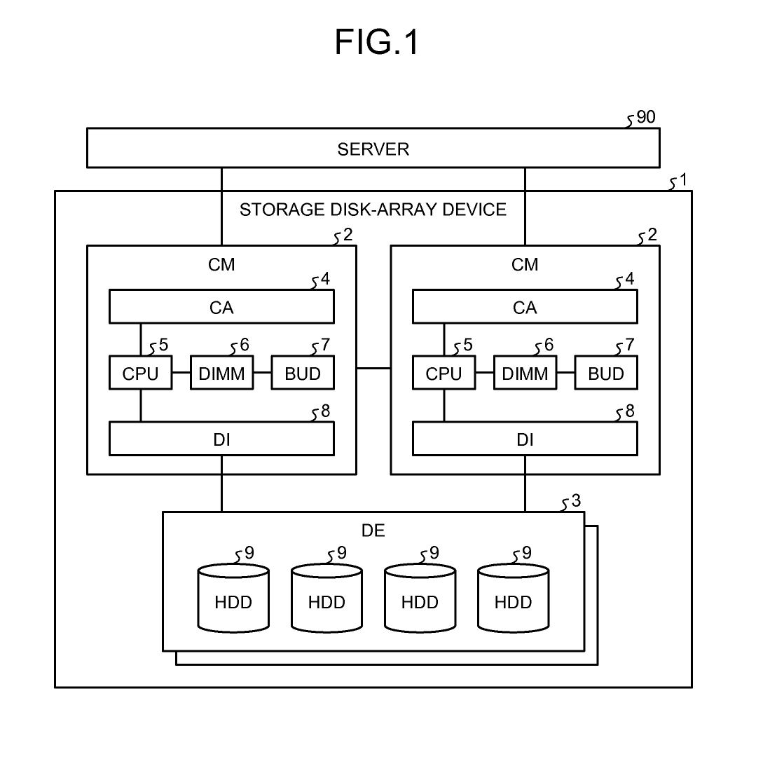

First, a configuration of a storage disk-array device according to a first embodiment is explained. The storage disk-array device is a storage system equipped with multiple disks. FIG. 1 is a block diagram indicating a configuration of a storage disk-array device according to a first embodiment. As indicated in FIG. 1, a storage disk-array device 1 includes two units of CMs 2, and two units of drive enclosures (DE) 3. Although two units of the DEs are indicated in this example for convenience of explanation, the storage disk-array device 1 can have an arbitrary number of the DE 3.

The CM 2 is a controller that controls the storage disk-array device 1, and is duplicated. The CM 2 includes a channel adapter (CA) 4, a CPU 5, a dual in-line memory module (DIMM) 6, a boot-up and utility device (BUD) 7, and a drive interface (DI) 8.

The CA 4 is an interface to a server 90 that uses the storage disk-array device 1. The CPU 5 is a central processing unit that implements a control function of the storage disk-array device 1 by executing CM firmware that is stored in the DIMM 6. The DIMM 6 is a memory module that is equipped with multiple dynamic random access memories (DRAMs), and stores programs and data.

The BUD 7 is a non-volatile memory that stores firmware and the like, and is, for example, a solid state drive (SSD). The DI 8 is an interface to the DE 3. The DE 3 is a storage device that is equipped with four units of HDDs 9. Although four units of the HDDs 9 are indicated in this example for convenience of explanation, the DE 3 can have an arbitrary number of the HDD 9.

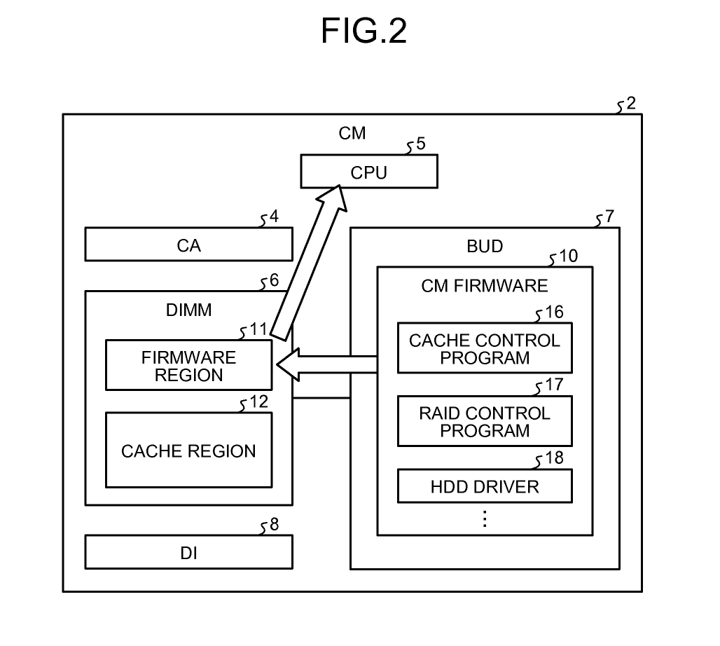

FIG. 2 indicates a storage location of the CM firmware and execution of the CM firmware by the CPU 5. As indicated in FIG. 2, CM firmware 10 is stored in the BUD 7. The CM firmware 10 is loaded into a firmware region 11 in the DIMM 6 from the BUD 7, and is read by the CPU 5 from the DIMM 6 to be executed. The DIMM 6 has a cache region 12 that is used for caching data, other than the firmware region 11.

The CM firmware 10 includes a cache control program 16, a redundant arrays of inexpensive disks (RAID) control program 17, and an HDD driver 18. The cache control program 16 performs cache control using the cache region 12. The RAID control program 17 performs RAID control of the DE 3.

The HDD driver 18 performs control of issuance of a command to the HDD 9 based on a command received from the server 90. Moreover, the HDD driver 18 transmits a result of response from the HDD 9 to the server 90.

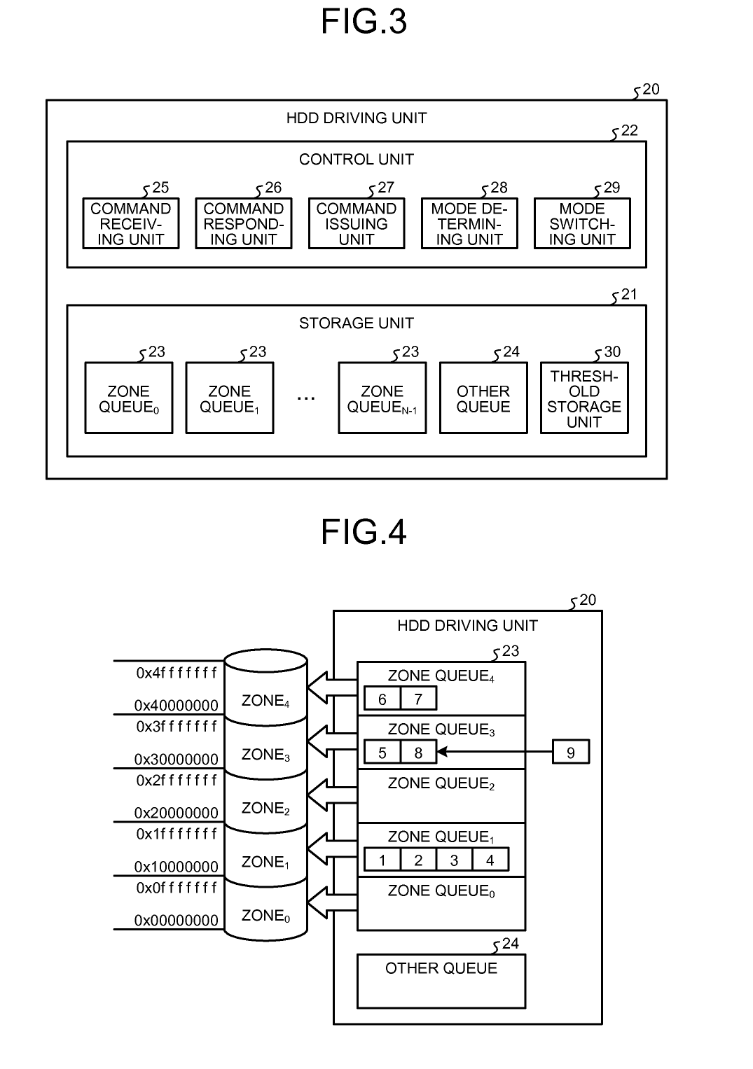

Next, a functional configuration of an HDD driving unit that is implemented by the CPU 5 executing the HDD driver 18 is explained. FIG. 3 is a block diagram indicating the functional configuration of the HDD driving unit. As indicated in FIG. 3, a HDD driving unit 20 includes a storage unit 21 and a control unit 22.

The storage unit 21 is a region in which data is stored, and includes N pieces of zone queues 23, other queue 24, and a threshold storage unit 30. The N pieces of zone queues 23 are queues that are associated with N pieces of zones obtained by dividing a data storage region provided by the storage disk-array device 1 into N pieces, respectively. Each of the zone queues 23 stores read commands and write commands that are issued for each of the zones.

The HDD 9 has an upper limit in the receivable number of commands, and if more commands than the upper limit are issued to the HDD 9, the HDD 9 responses as TASK SET FULL. Therefore, the HDD driving unit 20 manages and controls the number of command issuance to each zone by a queuing function such that an excessive amount of commands are not issued to the HDD 9.

Each of the zone queues 23 performs queuing of commands exceeding the maximum number of command issuance that is determined by the HDD driving unit 20. When command issuance to the HDD 9 is enabled by a command response from the HDD 9 and the like, the HDD driving unit 20 dequeues a command from a head of the zone queue 23 to issue to the HDD 9.

The other queue 24 performs queuing of commands other than a read command and a write command. The threshold storage unit 30 stores threshold values of the number of commands that are consecutively dequeued from the single zone queue 23.

The control unit 22 performs a command issuance processing to the HDD 9 using the storage unit 21, and a processing for a response from the HDD 9. The control unit 22 includes a command receiving unit 25, a command responding unit 26, a command issuing unit 27, a mode determining unit 28, and a mode switching unit 29.

The command receiving unit 25 receives a command from the server 90 through the CA 4, and issues a command to the HDD 9 when it is in a state in which a command can be issued right away. On the other hand, when a command cannot be issued right away, the command receiving unit 25 performs queuing into either one of the N pieces of the zone queues 23 and the other queue 24 based on a type of the command and an address of an access destination.

Moreover, the command receiving unit 25 queues a command into an end of a queue by adding a time stamp to the command when queues the command into the zone queue 23. The time stamp is used to select the zone queue 23 to be a target of dequeue (hereinafter, “target queue”). Furthermore, a command is processed in first in first out (FIFO) order inside a zone.

FIG. 4 indicates an example of queuing operation. FIG. 4 indicates a case in which the data storage region provided by the storage disk-array device 1 is divided into five. In FIG. 4, a rectangular in the zone queue 23 indicates a command, and a number inside the rectangular indicates the time stamp. As indicated in FIG. 4, when a command having time stamps of 1 to 8 is queued, the time stamp of 9 is added in the case in which a new command is queued.

Returning back to FIG. 3, the command responding unit 26 accepts a response form the HDD 9 to the issued command, and responds to the server 90 through the CA 4.

The command issuing unit 27 dequeues a command from either queue when issuance of a command is enabled and a queued command is present, and issues a command to the HDD 9. At that time, commands accumulated in the other queue 24 are commands related to control of the HDD 9, and are commands that are preferred to be executed on a priority basis. Therefore, when a command is queued in the other queue 24, the command issuing unit 27 dequeues a command in the other queue 24 on a priority basis, and when no command is queued in the other queue 24, dequeues from the zone queue 23.

The command issuing unit 27 consecutively issues commands to an identical zone to reduce seek loss at the time of dequeuing from the zone queue 23. The command issuing unit 27 holds a target queue out of the N pieces of the zone queues 23, and consecutively issues commands to an identical zone by dequeuing a command from the target queue.

The command issuing unit 27 performs update determination of a target queue at the time of dequeuing. Specifically, the command issuing unit 27 performs the update determination of a target queue by determining whether the number of commands that have been dequeued by the current target queue has reached the threshold value. That is, the command issuing unit 27 updates the target queue when the number of commands dequeued by the current target queue reaches the threshold value. The threshold value is not a static fixed value, but a dynamic value that varies according to access conditions, and is a value that is changed by the mode switching unit 29.

The command issuing unit 27 compares time stamps in commands at heads of the respective zone queues 23, and determines the zone queue 23 in which the command having the oldest time stamp in the head command is queued as the target queue.

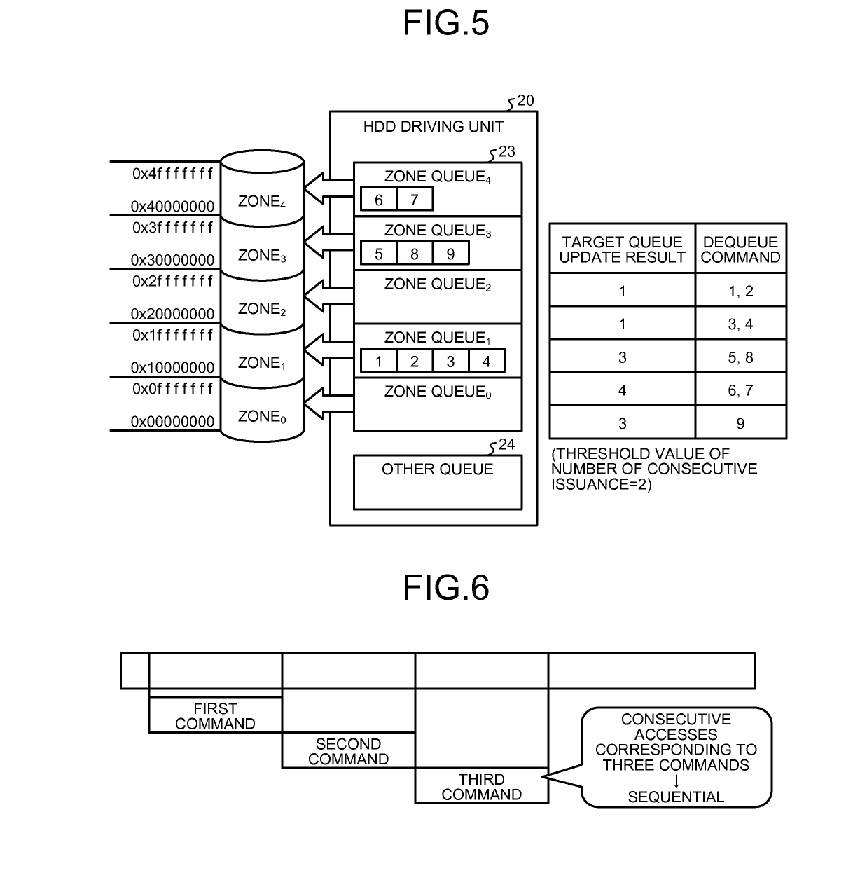

FIG. 5 indicates an example of dequeue operation. FIG. 5 indicates a case in which the threshold value of the number of consecutive issuance from a target queue is 2. When dequeue is performed in the state of the zone queues 23 indicated in FIG. 5, the zone queue 23 having the oldest time stamp in the head command out of five pieces of the zone queues 23 is a zone queue₁. Therefore, the zone queue₁ is first selected as the target queue, and commands with the time stamps of 1 and 2 are issued.

Subsequently, the zone queue 23 the head command of which has the oldest time stamp out of the five zone queues 23 is the zone queue₁ that stores a command having the time stamp of 3, and therefore, the zone queue₁ is selected as the target queue again. As a result, commands having the time stamps of 3 and 4 are issued.

Subsequently, the zone queue 23 the head command of which has the oldest time stamp out of the five zone queues 23 is the zone queue₃ that stores a command having the time stamp of 5, and therefore, the zone queue₃ is selected as the target queue. As a result, commands having the time stamps of 5 and 8 are issued.

Subsequently, the zone queue 23 the head command of which has the oldest time stamp out of the five zone queues 23 is the zone queue₄ that stores a command having the time stamp of 6, and therefore, the zone queue₄ is selected as the target queue. As a result, commands having the time stamps of 6 and 7 are issued.

Finally, the zone queue 23 the head command of which has the oldest time stamp out of the five zone queues 23 is the zone queue₃ that stores a command having the time stamp of 9, and therefore, the zone queue3 is selected as the target queue again. As a result, a command having the time stamp of 9 is issued.

As described, by selecting the zone queue 23 the head command of which has the oldest time stamp as the target queue, the head of the selected zone queue 23 is always the oldest command, and therefore, the HDD driving unit 20 can suppress command sinking.

Returning back to FIG. 3, the mode determining unit 28 determines which of response time or throughput is prioritized based on an access condition to the HDD 9. The response time is time required for a response from reception of a command from the server 90, and the throughput is a cache data transfer amount per unit time.

When the response time is prioritized, the mode determining unit 28 determines that it is in a response priority mode, and when the throughput is prioritized, the mode determining unit 28 determines that it is in a throughput priority mode. Moreover, when it is not in either the response priority mode or the throughput priority mode, the mode determining unit 28 determines that it is in a neutral mode.

Specifically, the mode determining unit 28 determines a mode based on which of sequential access or random access is performed, and on a ratio between write commands and read commands. Because the sequential access is sequential data access, performance in the throughput can be improved by consecutively issuing commands to an identical zone. On the other hand, if excessively consecutive issuance is performed in random access, deterioration of response (response time) caused by stagnant commands, time out occurred by deterioration in response, or the like occurs, and therefore, response is necessary to be taken into consideration.

Furthermore, writeback processing in which data in a cache is written in the HDD 9 is not synchronous with a host response of a write command, and therefore, is not affected by the response time of the HDD driving unit 20. Accordingly, when commands are mainly the write command, it is preferable that improvement of throughput be prioritized. On the other hand, as for read commands, because a host response thereof is affected by the response time of the HDD driving unit 20, when commands are mainly the read command, it is desirable that deterioration of the response time be avoided as much as possible.

Therefore, when sequential access is being performed, the mode determining unit 28 determines that it is in the throughput priority mode. Moreover, when random access is being performed, the mode determining unit 28 determines that it is in the throughput priority mode if commands are mainly of write, and determines that it is in the response priority mode if commands are mainly of read.

FIG. 6 indicates an example of a method of determining sequential access. The storage disk-array device 1 checks an access range from the server 90 in units of RLU (RAID logical unit). As indicated in FIG. 6, the mode determining unit 28 determines that access to the RLU is sequential access when there are a predetermined number (for example, three) or more sequential access commands to sequential regions, and determines as random access in other cases. The mode determining unit 28 regards the access trend of the RLU including the HDD 9 to be a subject as the access trend of the HDD 9 to utilize the access trend.

Furthermore, the mode determining unit 28 determines whether commands are mainly of read or mainly of write based on a ratio between the number of read commands and the number of write commands. That is, when read commands constitute a predetermined rate (for example, 90%) or more of entire commands, the mode determining unit 28 determines that commands are mainly of read, and when write commands constitute a predetermined rate (for example, 90%) or more of entire commands, determines that commands are mainly of write. Moreover, when commands are not mainly of read nor of write, the mode determining unit 28 determines that read and write are mixed. The number of read commands and the number of write commands are counted by the command receiving unit 25 at the time of queuing the commands.

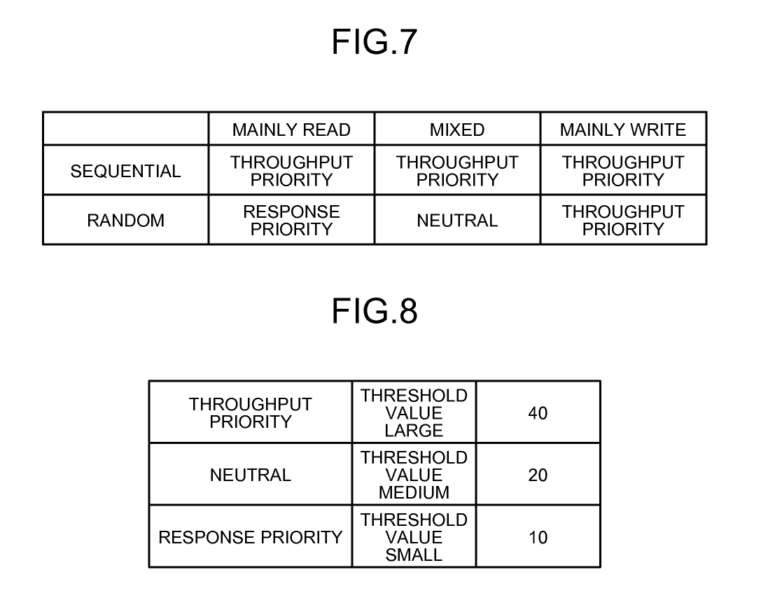

FIG. 7 indicates a mode determination method. As indicated in FIG. 7, when access is sequential, the mode determining unit 28 determines as the throughput priority mode regardless of the ratio between the number of read commands and the number of write commands. On the other hand, when access is random, the mode determining unit 28 determines as the response priority mode if commands are mainly of read, determines as the throughput priority mode if commands are mainly of write, and determines as the neutral mode when read and write are mixed.

The mode switching unit 29 updates the threshold value of the number of commands to be issued consecutively from the target queue based on a result of mode determination by the mode determining unit 28. FIG. 8 indicates an example of threshold value corresponding to each mode. As indicated in FIG. 8, in the case of the throughput priority mode, the threshold value is large, and is 40, for example. In the case of the neutral mode, the threshold value is medium, and is 20, for example, in the case of the response priority mode, the threshold value is small, and is 10, for example.

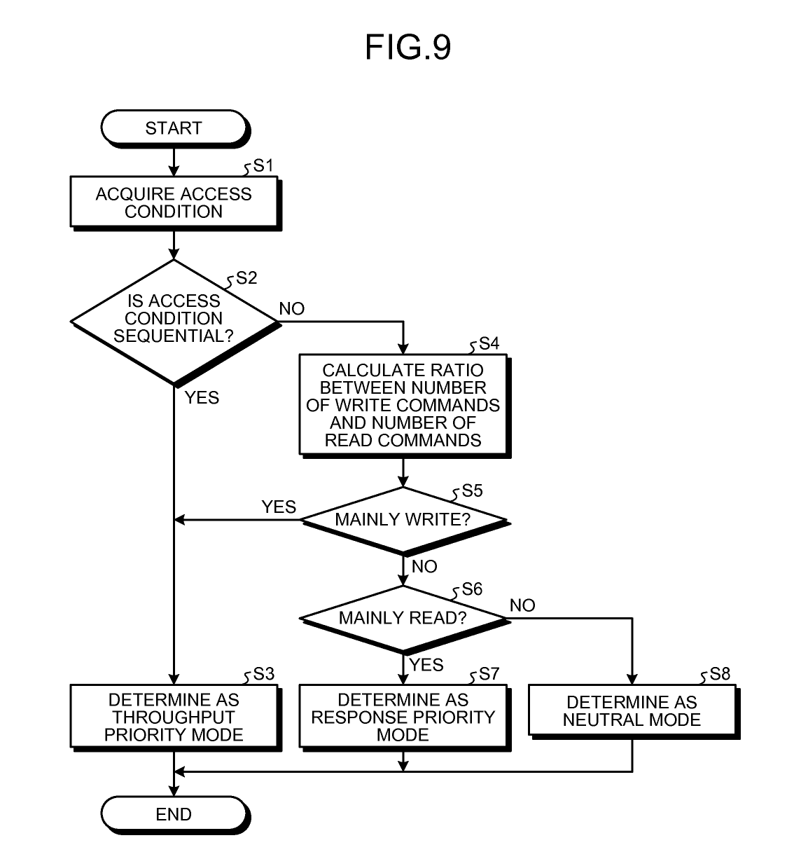

Next, a flow of the mode determination processing is explained. FIG. 9 is a flowchart indicating a flow of the mode determination processing. As indicated in FIG. 9, the mode determining unit 28 first acquires an access condition (step S1). The mode determining unit 28 then determines the access condition is random or sequential (step S2). As a result, when the access condition is sequential, the mode determining unit 28 determines as the throughput priority mode (step S3).

On the other hand, when the access condition is not sequential, the mode determining unit 28 calculates the ratio between the number of write commands and the number of read commands (step S4), and determines whether commands are mainly of write (step S5). As a result, the mode determining unit 28 determines as the throughput priority mode when commands are mainly of write (step S3), and determines whether the commands are mainly of read when commands are not mainly of write (step S6). As a result, the mode determining unit 28 determines as the response priority mode when the commands are mainly of read (step S7), and determines as the neutral mode when the commands are not mainly of read (step S8).

As described, by determining a mode by the mode determining unit 28, the mode switching unit 29 can change the threshold value of the number of commands that are consecutively issued from the target queue dynamically, based on the mode.

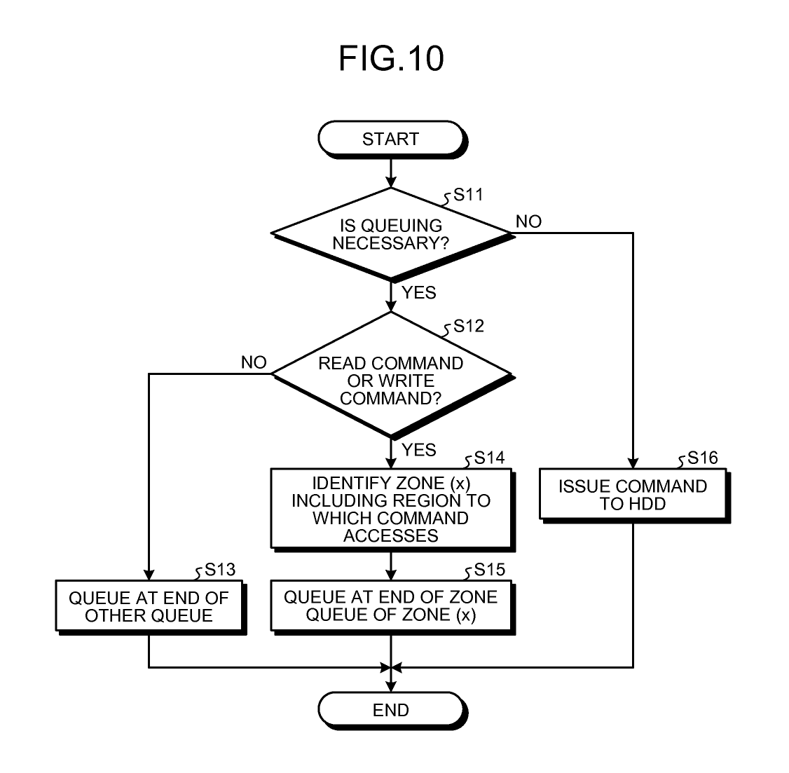

Next, a flow of commands reception processing is explained. FIG. 10 is a flowchart indicating a flow of the command reception processing. As indicated in FIG. 10, when receiving a commands, the command receiving unit 25 determines whether queuing is necessary (step S11), and issues a command to the HDD 9 when queuing is not necessary (step S16).

On the other hand, when queuing is necessary, the command receiving unit 25 determines which of a read command or a write command the received command is (step S12). As a result, when the command is neither a read command nor a write command, the command receiving unit 25 queues the commands at the end of the other queue 24 (step S13).

On the other hand, when the command is a read command or a write command, the command receiving unit 25 identifies a zone (x) that includes a region to which the command accesses (step S14), and adds a time stamp to the command and queues the command at the end of the zone queue 23 of the zone (x) (step S15).

As described, by queuing a command into one of the zone queues 23 by the command receiving unit 25, the command issuing unit 27 can issue commands to access to an identical zone consecutively.

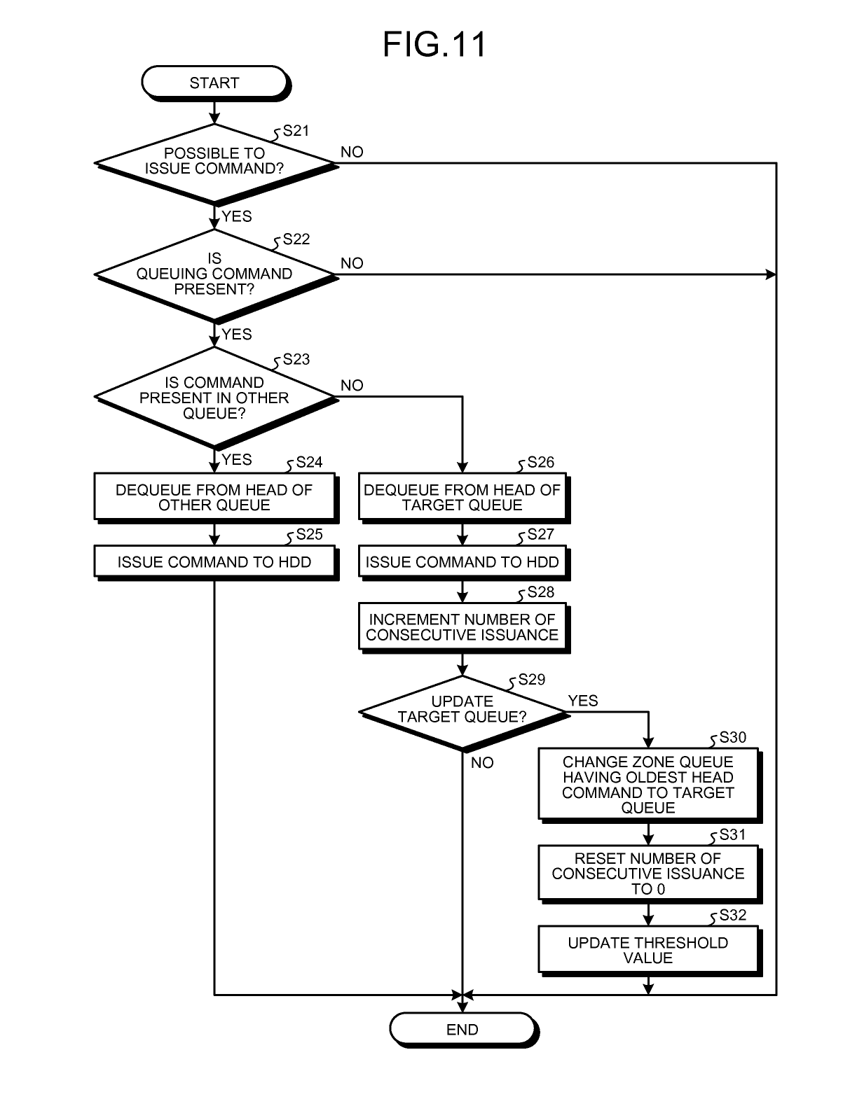

Next, a flow of command issuance processing is explained. FIG. 11 is a flowchart indicating a flow of the command issuance processing. As indicated in FIG. 11, when there is a command response from the HDD 9, the command issuing unit 27 determines whether it is possible to issue a command (step S21). As a result, when it is not possible to issue a command, the command issuing unit 27 ends the processing.

On the other hand, when it is possible to issue a command, the command issuing unit 27 determines whether a queuing command is present (step S22), and ends the processing when a queuing command is not present.

On the other hand, when a queuing command is present, the command issuing unit 27 determines whether a command is present in the other queue 24 (step S23). As a result, when a command is present in the other queue 24, the command issuing unit 27 dequeues from the head of the other queue 24 (step S24), and issues a command to the HDD 9 (step S25).

On the other hand, when a command is not present in the other queue 24, the command issuing unit 27 dequeues from the head of the target queue (step S26), and issues a command to the HDD 9 (step S27). The command issuing unit 27 then increments the number of consecutive issuance (step S28), and determines whether to update the target queue (step S29). As a result, when the target queue is not updated, the command issuing unit 27 ends the processing.

On the other hand, when the target queue is updated, the command issuing unit 27 changes the target queue to the zone queue 23 the head command of which is the oldest (step S30), and resets the number of consecutive issuance to 0 (step S31). The mode determining unit 28 then determines the mode, and the mode switching unit 29 updates the threshold value of the consecutive issuance based on the mode (step S32).

As described, by determining the mode by the mode determining unit 28, and by updating the threshold value of the consecutive issuance by the mode switching unit 29 based on the mode, the HDD driving unit 20 can change the threshold value of the consecutive issuance dynamically.

As described above, in the first embodiment, the mode determining unit 28 determines which of the response time and the throughput is prioritized based on an access condition to the HDD 9, and the mode switching unit 29 updates the threshold value of the consecutive issuance based on a result of determination by the mode determining unit 28. Therefore, the HDD driving unit 20 can prevent command sinking while maintaining the effect of zone division.

Moreover, in the first embodiment, the mode determining unit 28 determines which of the response time and the throughput is prioritized based which of sequential access or random access is performed, and on a ratio between the number of read commands and the number of write commands. Therefore, the mode determining unit 28 can determine the mode appropriately based on the access condition to the HDD 9.

### [b] Second Embodiment

Although the threshold value of the consecutive issuance is changed based on a trend of commands issued to the HDD 9 in the first embodiment, there is a case in which there is a performance value desired to be maintained as a requirement of the storage disk-array device 1. For example, there is a performance value such that it is desired to have a response from the server 90 within certain time to prevent timeout, or it is desired to maintain certain throughput or higher so that processing is not delayed. Therefore, in a second embodiment, a storage disk-array device that has a type of performance desired to be prioritized as a device, and worst values and target values of performance in response time and throughput, in advance, and that achieves the performance value by adjusting a threshold value based on comparison between these values and actual measurement values is explained.

The worst value is a value that indicates that if a performance value is lower than this value, immediate improvement is required, and it is, for example, response time that can cause timeout, or the like. The target value is a performance value that is desirable to be achieved as much as possible as a device. The actual measurement value is an actual performance value of the device that is collected in the device. Moreover, as the method of taking an actual measurement value of each performance, for response time, response times of latest three commands are averaged, and for throughput, a snapshot of a throughput performance at the time of performance collection is taken.

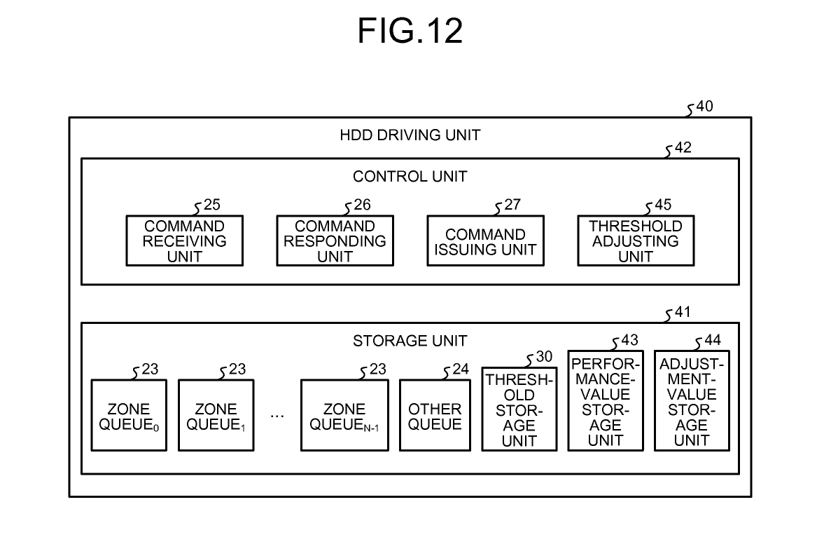

First, a functional configuration of an HDD driving unit according to the second embodiment is explained. FIG. 12 is a block diagram indicating a functional configuration of an HDD driving unit according to the second embodiment. For convenience of explanation, like reference symbols are given to functional units achieving similar roles as respective components indicated in FIG. 3, and detailed explanation thereof is omitted.

As indicated in FIG. 12, a storage unit 41 of an HDD driving unit 40 includes N pieces of the zone queues 23, the other queue 24, the threshold storage unit 30, a performance-value storage unit 43, and an adjustment-value storage unit 44. The performance-value storage unit 43 stores priority on response, priority on throughput, or neutral as priority items that are types of performances desired to be prioritized, and stores a worst value and a target value for each of the response time and the throughput. A user may set the worst value and the target value, or may use ones set in the performance-value storage unit 43 in advance.

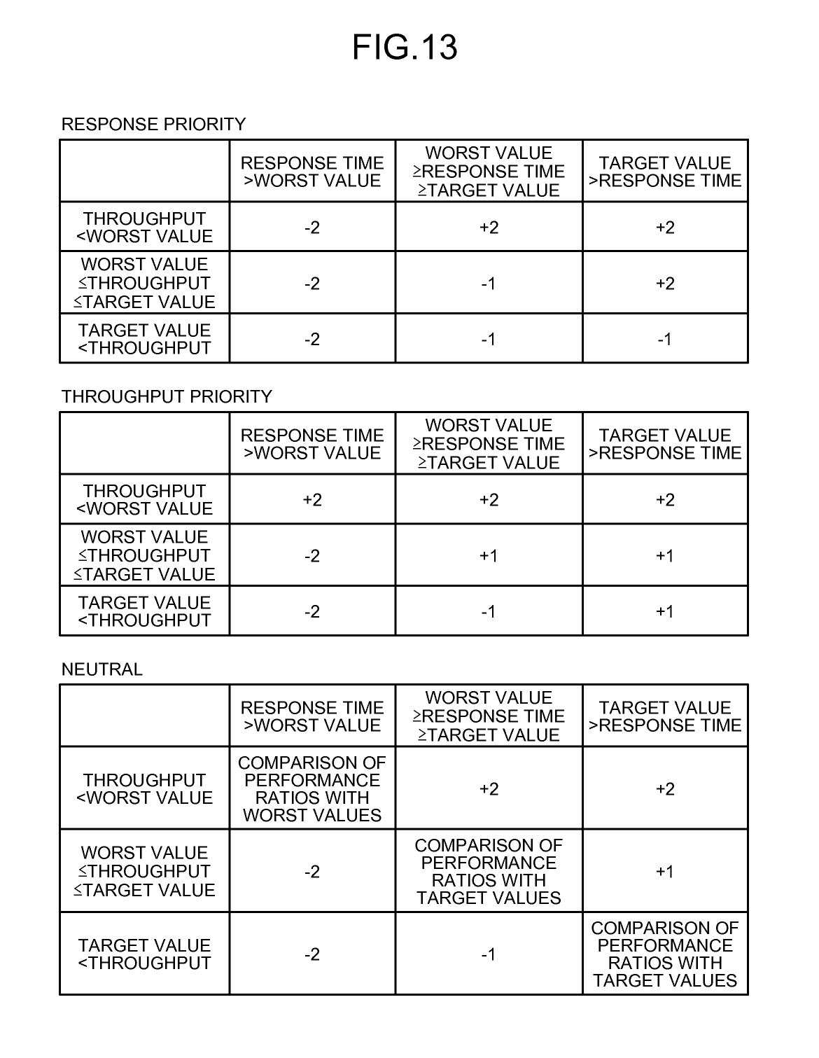

The adjustment-value storage unit 44 stores an adjustment value of a threshold value for each of the priority items. FIG. 13 indicates an example of adjustment values stored in the adjustment-value storage unit 44. As indicated in FIG. 13, the adjustment-value storage unit 44 stores adjustment values based on relation among actual measurement values, worst values, and target values of response time and throughput for the cases of priority on response, priority on throughput, and neutral, in three reference tables.

Specifically, in each table of each priority item, the adjustment values are stored categorizing the response time into cases for each of a case in which the actual measurement value of throughput is smaller than the worst value, a case in which the actual measurement value of throughput is equal to or larger than the worst value and smaller than the target value, and a case in which the actual measurement value of throughput is larger than the target value. Categorized cases of the response time include a case in which an actual measurement value of the response time is larger than the worst value, a case in which the actual measurement value of the response time is larger than the target value and smaller than the worst value, and a case in which an actual measurement value of the response time is smaller than the target value. In FIG. 13, an actual measurement value of throughput is expressed as “throughput”, and an actual measurement value of response time is express as “response time”.

As for the adjustment value, when it is a positive value, the number of consecutive issuance of commands from the target queue is increased, and therefore, the throughput is improved. When it is a negative value, the number of consecutive issuance of commands is decreased, and therefore, the response time is improved.

For example, in the case of priority on response, when an actual measurement value of throughput is smaller than the worst value and an actual measurement value of response time is larger than the worst value, it is necessary to reduce the response time, and therefore, the threshold value is required to be a smaller value, and the adjustment value is −2. On the other hand, in the case of priority on throughput, when an actual measurement value of throughput is smaller than the worst value, and an actual measurement value of response time is larger than the worst value, it is necessary to increase the throughput, and therefore, the threshold value is required to be a larger value, and the adjustment value is +2.

Moreover, in the case of priority on response, when the throughput is larger than the target value and the response time is smaller than the target value, although both exceed the target values, because priority is placed on response, the adjustment value is −1. On the other hand, in the case of priority on throughput, when the throughput is larger than the target value and the response time is smaller than the target value, although both exceed the target values, because priority is placed on throughput, the adjustment value is +1.

Furthermore, in the case of neutral, when the throughput and the response time are both worse than the worst values, the adjustment value is to be a value based on performance ratios of the throughput and the response time to the worst values. On the other hand, when the throughput and the response time both exceed the target values, or when the throughput and the response time are both within a range between the worst values and the target values, the adjustment value is to be a value based on performance ratios of the throughput and the response time to the target values.

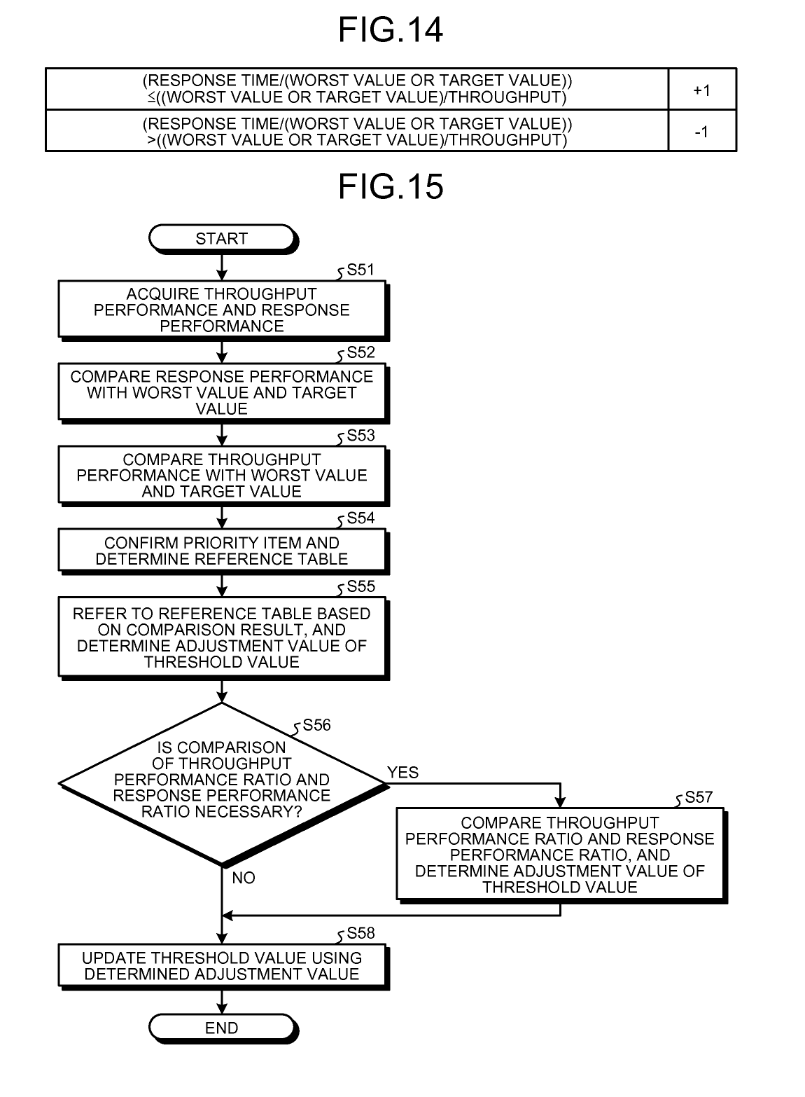

FIG. 14 indicates an example of the adjustment values based on the performance ratios. As indicated in FIG. 14, when the throughput and the response time are both worse than the worst values, the adjustment value is such a value that improves a worse one of ratios based on the ratios of actual measurement values of the throughput and the response time to the worst values. Moreover, when the throughput and the response time both exceed the target values or when the throughput and the response time are both within a range between the worst values and the target values, the adjustment value is such that a value that improves the worse one of ratios based on the ratios of actual measurement values of the throughput and the response time to the target values. The adjustment values based on the performance ratios are also stored in the adjustment-value storage unit 44.

Returning back to FIG. 12, a control unit 42 of the HDD driving unit 40 includes the command receiving unit 25, the command responding unit 26, the command issuing unit 27, and a threshold adjusting unit 45. The threshold adjusting unit 45 updates the threshold value of consecutive issuance of commands from a target queue based on the performance-value storage unit 43 and the adjustment-value storage unit 44. An initial value of the threshold value is a predetermined value such as 30.

Next, a flow of threshold update processing according to the second embodiment is explained. FIG. 15 is a flowchart indicating a flow of threshold update processing according to the second embodiment. As indicated in FIG. 15, the threshold adjusting unit 45 acquires a throughput performance and a response performance (step S51). The throughput performance is an actual measurement value of throughput, and the response performance is an actual measurement value of response time.

The threshold adjusting unit 45 then compares the response performance with the worst value and the target value (step S52), and compares the throughput performance with the worst value and the target value (step S53). The threshold adjusting unit 45 confirms the priority item, and determines a reference table (step S54). The threshold adjusting unit 45 then refers to the reference table for each of the response performance and the throughput performance based on comparison results with the worst value and the target value, to determine the adjustment value of the threshold value (step S55).

Furthermore, the threshold adjusting unit 45 determines whether comparison of a throughput performance ratio and a response performance ratio is necessary as a result of reference to the reference table (step S56). The throughput performance ratio is a ratio between an actual measurement value of throughput and the target value or the worst value, and the response performance ratio is a ratio between an actual measurement value of response time and the target value and the worst value. Note that if the throughput performance ratio is a ratio between an actual measurement value and the target value, the response performance ratio is also a ratio between an actual measurement value and the target value, if the throughput performance ratio is a ratio between an actual measurement value and the worst value, the response performance ratio is also a ratio between an actual measurement value and the worst value.

When determining that comparison of the throughput performance ratio and the response performance ratio is necessary, the threshold adjusting unit 45 compares the throughput performance ratio and the response performance ratio, and determines an adjustment value of the threshold value (step S57).

The threshold adjusting unit 45 then updates the threshold value using the determined adjustment value (step S58).

As described above, in the second embodiment, the threshold adjusting unit 45 updates the threshold value based on the target value and the worst value of response time and throughput. Therefore, when there is a performance value that is desired to be maintained as a requirement of the device, the HDD driving unit 40 can control command issuance to the HDD 9 such that the performance value is maintained.

Moreover, in the second embodiment, in the case in which neither response time nor throughput is to be prioritized, when both response time and throughput are worse than the worst values, the threshold value is updated based on a ratio of the response time to the worst value and a ratio of the throughput to the worst value. Therefore, the HDD driving unit 40 can improve either one of the response time and the throughput having a worse performance ratio to the worst value of response time and throughput.

Furthermore, in the second embodiment, in the case in which neither response time nor throughput is to be prioritized, when both response time and throughput are better than the target values, the threshold value is updated based on a ratio of the response time to the target value and a ratio of the throughput to the target value. Therefore, the HDD driving unit 40 can improve either one of the response time and the throughput having a worse performance ratio to the target value of response time and throughput.

Moreover, in the second embodiment, in the case in which neither response time nor throughput is to be prioritized, when both response time and throughput are within a range between the target value the worst value, the threshold value is updated based on a ratio of the response time to the target value and a ratio of the throughput to the target value. Therefore, the HDD driving unit 40 can improve either one of the response time and the throughput having a worse performance ratio to the target value of response time and throughput.

### [c] Third Embodiment

In the first embodiment, a case in which the threshold value is determined by determining which of response time and throughput is to be prioritized is explained, and in the second embodiment, a case in which the threshold value is updated based on the target values and the worst values of response time and throughput is explained. Although the first embodiment and the second embodiment can be practiced separately, the first embodiment and the second embodiment can be combined. Therefore, in a third embodiment, a case in which the first embodiment and the embodiment are combined is explained.

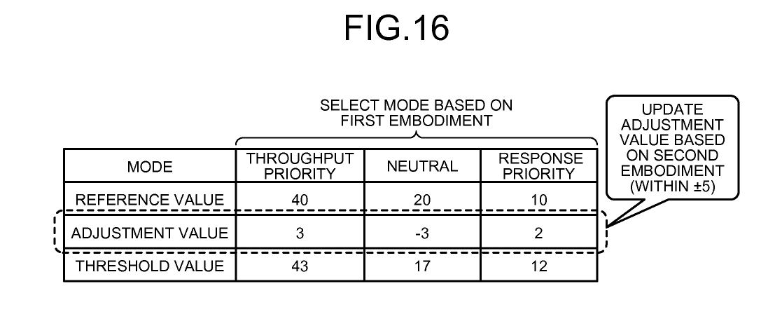

An HDD driving unit according to the third embodiment determines a reference value of the threshold value based on the first embodiment, and determines an adjustment value of the threshold value based on the second embodiment. FIG. 16 indicates an example of a determination table that holds determination results of the threshold value.

As indicated in FIG. 16, the HDD driving unit according to the third embodiment determines a mode, the throughput priority mode, the response priority mode, or the neutral mode based on the first embodiment, and determines a reference value of the threshold value. For example, the HDD driving unit according to the third embodiment determines the threshold value as 40 when throughput is prioritized, determines the threshold value as 20 when neutral, and determines the threshold value as 10 when response is prioritized.

The HDD driving unit according to the third embodiment determines an adjustment value based on the second embodiment from the priority item, and actual measurement values, the target values, and the worst values of response time and throughput. For example, the HDD driving unit according to the third embodiment determines the adjustment value of the threshold value as 3 when throughput is prioritized, determines the adjustment value of the threshold value as −3 when neutral, and determines the adjustment value of the threshold value as 2 when response is prioritized. Note that a range of the adjustment value is, for example, an absolute value of 5 or less.

The HDD driving unit according to the third embodiment uses a sum of the reference value and the adjustment value, as the threshold value. For example, the HDD driving unit according to the third embodiment determines the threshold value as 43 when throughput is prioritized, determines the threshold value as 17 when neutral, and determines the threshold value as 12 when response is prioritized.

The reason why the adjustment values of respective modes are held as the determination table is because when the mode returns again to one mode as “throughput priority”→“neutral”→“throughput priority”, the HDD driving unit can reuse adjustment results of the mode in previous times.

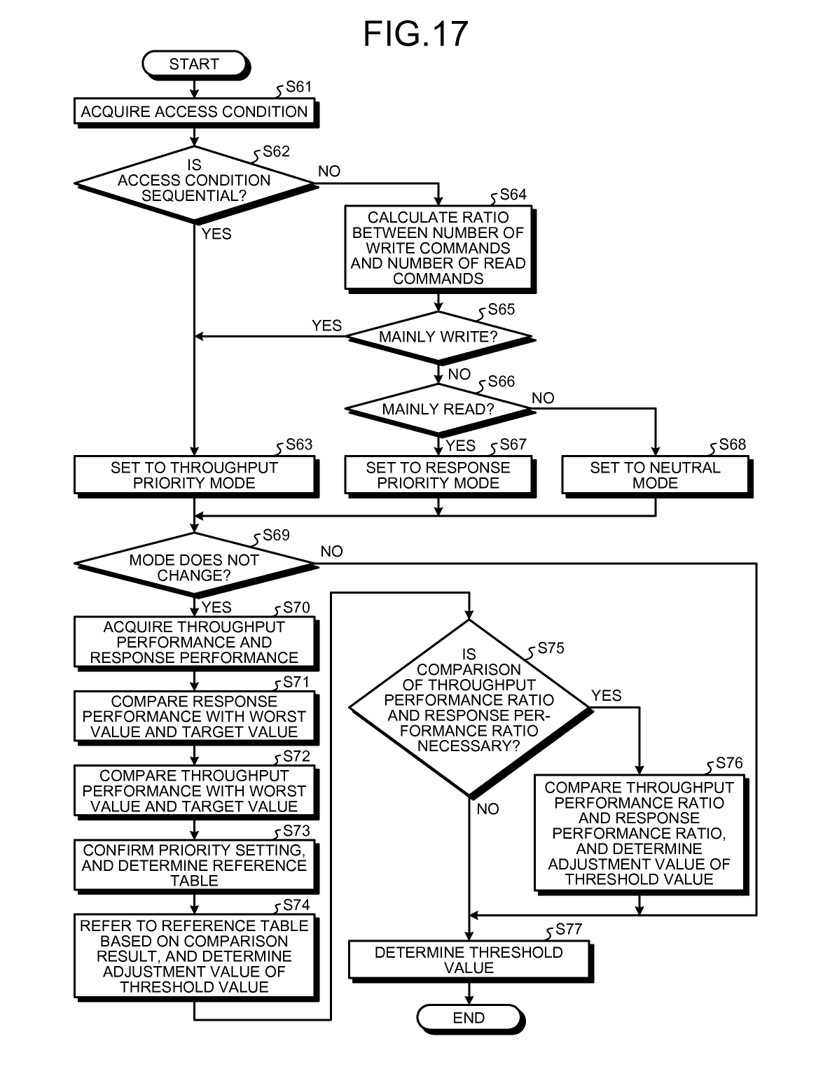

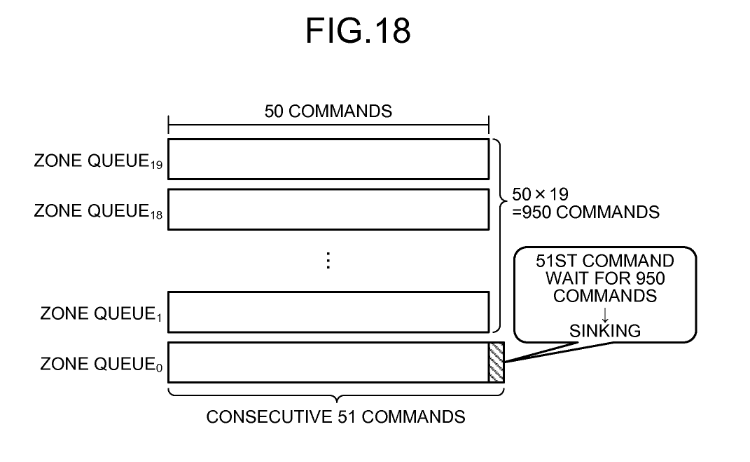

Next, a flow of threshold determining processing according to the third embodiment is explained. FIG. 17 is a flowchart indicating a flow of the threshold determination processing according to the third embodiment. As indicated in FIG. 17, the mode determining unit 28 first acquires an access condition (step S61). The mode determining unit 28 then determines the access condition is random or sequential (step S62). As a result, when the access condition is sequential, the mode determining unit 28 sets the mode to the throughput priority mode (step S63).

On the other hand, when the access condition is not sequential, the mode determining unit 28 calculates the ratio between the number of write commands and the number of read commands (step S64), and determines whether commands are mainly of write (step S65). As a result, the mode determining unit 28 sets the mode to the throughput priority mode when commands are mainly of write (step S63), and determines whether the commands are mainly of read when commands are not mainly of write (step S66). As a result, the mode determining unit 28 sets the mode to the response priority mode when the commands are mainly of read (step S67), and sets the mode to the neutral mode when the commands are not mainly of read (step S68).

The HDD driving unit according to the third embodiment determines whether the mode does not change (step S69), and determines the threshold value based on the reference value when the mode changes (step S77).

On the other hand, when the mode does not change, the threshold adjusting unit 45 acquires a throughput performance and a response performance (step S70). The threshold adjusting unit 45 then compares the response performance with the worse value and the target value (step S71), and compares the throughput performance with the worse value and the target value (step S72). The threshold adjusting unit 45 confirms a priority setting and determines the reference table (step S73). The threshold adjusting unit 45 then refers to the reference table based a comparison results of the response performance and the throughput performance with the worst values and the target values, to determine the adjustment value of the threshold value (step S74).

Furthermore, the threshold adjusting unit 45 determines whether comparison of the throughput performance ratio and the response performance ratio is necessary as a result of reference to the reference table (step S75). When determining that comparison of the throughput performance ratio and the response performance ratio is necessary, the threshold adjusting unit 45 then compares the throughput performance ratio and the response performance ratio, and determines the adjustment value of the threshold value (step S76). The threshold adjusting unit 45 then updates the threshold value using the determined reference value and the adjustment value (step S77).

As described above, the HDD driving unit according to the third embodiment determines the threshold value using the reference value that is determined based on the first embodiment and the adjustment value that is determined based on the second embodiment. Therefore, the HDD driving unit according to the third embodiment can determine the threshold value appropriately based on the access condition to the HDD 9.

Furthermore, although the storage disk-array device has been explained in the embodiments, the present invention is not limited thereto, and is similarly applicable to a storage apparatus using a storage device that performs seek operation.

According to one embodiment, it is possible to prevent command sinking while maintaining effects of zone division.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device that queues a command for each zone that is acquired by dividing a storage region, and that issues commands from a queue of each zone in a consecutive manner, the storage control device comprising:
an updating unit that updates a threshold value of consecutive issuance of commands to a single zone on a basis of an access condition to the storage region; and
an issuance control unit that controls issuance of a command to each zone on a basis of the threshold value updated by the updating unit.

2. The storage control device according to claim 1, further comprising
a determining unit that determines which of response time or throughput is prioritized on a basis of the access condition to the storage region, wherein
the updating unit updates the threshold value on a basis of a result of determination by the determining unit.

3. The storage control device according to claim 2, further comprising
a judging unit that judges which of sequential access or random access is performed based on an access condition to the storage region, wherein
the determining unit determines which is to be prioritized, response time or throughput, based on a result of judgment by the judging unit.

4. The storage control device according to claim 3, wherein
when judging that random access is being performed, the judging unit judges mainly write or mainly read, and
the determining unit determines that throughput is prioritized when the judging unit judges that random access mainly of write is performed, and determines that response time is prioritized when the judging unit judges that random access mainly of read is performed.

5. The storage control device according to claim 1, wherein
the updating unit updates the threshold value on a basis of target values and worst values of response time and of throughput.

6. The storage control device according to claim 5, wherein
when neither response time nor throughput is to be prioritized, the updating unit updates the threshold value on a basis of a ratio of response time to the worst value and a ratio of throughput to the worst value when both the response time and the throughput are worse than the worst values.

7. The storage control device according to claim 5, wherein
when neither response time nor throughput is to be prioritized, the updating unit updates the threshold value on a basis of a ratio of response time to the target value and a ratio of throughput to the target value when both the response time and the throughput are better than the target value, or when both the response time and the throughput are within a range between the target value and the worst value.

8. A storage apparatus that includes a storage device and a storage control device that queues a command for each zone that is acquired by dividing a storage region, and that issues commands from a queue of each zone in a consecutive manner, wherein
the storage control device includes
an updating unit that updates a threshold value of consecutive issuance of commands to a single zone on a basis of an access condition to the storage region; and
an issuance control unit that controls issuance of a command to each zone on a basis of the threshold value updated by the updating unit.

9. A non-transitory computer-readable storage medium that stores a storage control program that queues a command for each zone that is acquired by dividing a storage region, and that issues commands from a queue of each zone in a consecutive manner, the storage control program causing a computer to execute a process comprising:
updating a threshold value of consecutive issuance of commands to a single zone on a basis of an access condition to the storage region; and
controlling issuance of a command to each zone on a basis of the updated threshold value.
